(19) United States
(12) Patent Application Publication
(10) Pub. No.: US 2007/0094079 A1
(43) Pub. Date: Apr. 26, 2007

(54) Method of offsetting wireless telecommunications device usage costs by placing and selling advertisements on wireless telecommunications devices

(76) Inventor: Scott Philip Brown, New York, NY (US)

Correspondence Address: Scott Philip Brown, Apt. J23, 729 Greenwich Street, New York, NY, 10014, US

(21) Appl. No.: 11/582,902

(22) Filed: Oct. 18, 2006

Related U.S. Application Data
(60) Provisional application No. 60/728,534, filed on Oct. 20, 2005.
(60) Provisional application No. 60/728,535, filed on Oct. 20, 2005.
(60) Provisional application No. 60/728,536, filed on Oct. 20, 2005.

(51) Int. Cl. G07G 1/14

(52) U.S. Cl. 705/14

(57) ABSTRACT

A method offsetting the cost of wireless telecommunication device usage through the placement of advertisements onto wireless telecommunication devices. Wireless telecommunication providers sell advertisers the opportunity to place visual advertisements on to the devices of its customers. The wireless telecommunication providers can enhance the revenue generated by such sales by providing user demographics to enable specific advertisements to target specific demographics. The method enables the providers to offset the cost to its customers by receipt of such advertisement generated revenue. The wireless telecommunication device user will have advertisements on the devices display that will not materially affect the operation of the device and be able to use such device at substantially lower costs.

### CROSS-REFERENCE TO RELATED APPLICATIONS

This application claims the benefit of provisional patent application 60/728,534; 60/728,535 and/or 60/728,536, as applicable each filed Oct. 20, 2005 by the present inventor.

### FEDERALLY SPONSORED RESEARCH

Not applicable.

### SEQUENCE LISTING OR PROGRAM

Not applicable

### BACKGROUND OF THE INVENTION

1. Field of Invention

This invention relates to the use of advertisements on wireless telecommunication devices and cellular phone displays to reduce the consumer cost of use.

2. Prior Art

Recent technological advances and methods of delivery advertisement content to wireless telecommunication devices primarily consists of internet connection whereby the device displays that which is displayed on the internet and its related advertisements.

Advertisers and wireless telecommunication providers have not tapped the potential that exists by advertising directly onto the wireless telecommunication device displays. Not only does this invention provide such a method with tremendous opportunity for advertisers to reach potential customers in a new venue, but it further permits more efficient and effective advertising in conjunction with the demographic statistics of users that wireless telecommunication providers have access to.

Wireless telecommunication device users pay considerable costs as their use of such devices have increased over the past several years. This invention will enable users to receive considerably lower costs as the fees charged to them will be offset by advertising revenue that wireless telecommunication providers obtain from advertisers.

### OBJECTS AND ADVANTAGES

The present invention presents several advantages to consumers, wireless telecommunications companies and advertisers. Principally, consumers will benefit from reduced, and perhaps even free, wireless telecommunication costs. As our nation has embraced the use of the technology of wireless telecommunications, our population has become one in which particularly cell phone usage is a universal trait of American life. As our population has embraced and increasingly use this technology, the costs for such use have accumulated. The present invention will enable such users to make cell phone calls and other wireless telecommunications connections at much lower costs with no interruption of service or quality.

Wireless telecommunications companies stand to benefit from the present invention by enabling them to offset the costs of their service to their customers from the advertising revenue they generate. As they can then lower costs to their customers, the wireless telecommunications companies can expand the volume of their customer base.

Advertisers can benefit from the present invention as it will enable them to target their advertisers to a largely fixed audience with frequent repeat views of the advertisements. This is an untapped advertising opportunity and can potentially enable advertisers to specifically target wireless telecommunication device users by demographics to achieve more efficient and effective advertising.

### SUMMARY

This invention consists of a method for using advertisements on wireless telecommunication devices and cellular phone displays to reduce the consumer cost of use. In essence, advertisers will pay wireless telecommunication providers for the right to place advertisements on the providers' customers' devices. The providers will then use the revenue generated from the advertisement payments to provide lower costs to its customers for their respective use.

### DRAWINGS

Not applicable.

### DETAILED DESCRIPTION

The present invention provides a method for using advertisements on wireless telecommunication devices to offset the cost to users. The method provides for advertisers to place visual advertisements onto wireless telecommunication devices including, but not limited to, cell phones.

Using this method, wireless telecommunication providers can pre-program wireless telecommunication devices upon purchase for new customers, or via programming through wireless electronic connection to the devices of existing customers, to display visual advertisements purchased by advertisers onto the devices of its wireless customers. With this invention, these advertisements can be static in the form of a background screen display, the “desktop”, or moving images on the screen of the wireless telecommunication device.

Under this method, advertisers, or companies wishing to advertise, can purchase this advertising space on wireless telecommunications devices from the wireless telecommunication providers. Wireless telecommunication providers can then offset the revenue received from the sale of such advertisements to provide its consumers with lower usage costs.

As most wireless telecommunication providers require that users complete an application prior to activating their wireless connection, providers have considerable demographic information concerning their customers including, but not limited to data on age, geographic location, sex, and potentially education and income levels. Under this invention method, such demographic data can be used and packaged to advertisers for the purchase of specific advertisements to the devices of differing users in a manner that enables specific demographic targeting,

Under this invention method, consumer will be able to use the wireless telecommunication devices without any relative disruption of standard operation of the device as the only difference from their current use would be an advertisement displayed on their desktop of the device. Wireless telecommunication providers can offer such consumers the ability to have substantially reduced usage costs, potentially free wireless cell phone service for up to certain use levels.

I claim:

1. A method of placing visual advertisements onto wireless telecommunication devices used by consumers displaying the advertisement onto the visual display of the device.

2. The method of claim 1 wherein the displaying of advertisements to specific wireless telecommunication device users is placed based on user demographics provided to advertisers from wireless telecommunication providers.

3. The method of claim 1 and/or 2 wherein wireless telecommunication providers offset the costs of service to its customers by revenue generated through the sale of advertisement placements onto the wireless telecommunication devices of its customers.

4. The method of claim 1 and/or 2 wherein such display of advertisement is in a visual static form or moving visual display.

5. The method of claim 1 and/or 2 wherein the advertisements are delivered to the wireless telecommunication device by pre-programming the device.

6. The method of claim 1 and/or 2 wherein the advertisements are delivered to the wireless telecommunication device by wireless electronic transmission from wireless telecommunication providers to the device via a program download sent directly from the providers or via the internet enabling the advertisements to be displayed.

7. The method of claim 1 and/or 2 wherein advertisements are displayed on users wireless telecommunication devices in a visual manner on the devices is desktop that does not substantially impair the user's use of the device.
